(19) United States
(12) Patent Application Publication
(10) Pub. No.: US 2024/0429464 A1
(43) Pub. Date: Dec. 26, 2024

(54) Mechanistic guidelines for suppressing dendrite formation in batteries

(71) Applicant: The Board of Trustees of the Leland Stanford Junior University, Stanford, CA (US)

(72) Inventors: Weiyu Li, Stanford, CA (US); Hamdi A. Tchelepi, Belmont, CA (US); Daniel M. Tartakovsky, San Carlos, CA (US)

(21) Appl. No.: 18/755,156

(22) Filed: Jun. 26, 2024

Related U.S. Application Data
(60) Provisional application No. 63/523,293, filed on Jun. 26, 2023.

(51) Int. Cl. H01M 10/42; H01M 4/62; H01M 10/0525

(52) U.S. Cl. CPC H01M 10/4235; H01M 4/628; H01M 10/0525

(57) ABSTRACT

Battery configurations that mitigate dendrite formation are considered. Control of local anisotropy and/or suitable surface roughness of the metal electrode are expected to mitigate dendrite formation based on modeling results that account for departure from electroneutrality.

### CROSS REFERENCE TO RELATED APPLICATIONS

This application claims priority from U.S. Provisional Patent Application 63/523,293 filed Jun. 26, 2023, which is incorporated herein by reference.

### GOVERNMENT SPONSORSHIP

This invention was made with Government support under contract FA9550-21-1-0381 awarded by the Air Force Office of Scientific Research. The Government has certain rights in the invention.

### FIELD OF THE INVENTION

This invention relates to mitigation of dendrite formation in batteries.

### BACKGROUND

Dendrite formation is a leading cause of degradation and catastrophic failure in batteries. Accordingly, it would be an advance in the art to better understand dendrite formation, and to better understand strategies for reducing dendrite formation.

### SUMMARY

In the detailed modeling example of section A below, we found that a local electric field close to the anode in lithium-metal batteries can lead to anisotropic ion diffusion that significantly affects dendrite formation.

We also found that dendrite growth can be affected by surface morphology. This suggests mitigating dendrite formation in batteries by appropriately introducing a local anisotropy and/or by introducing an appropriate surface morphology.

Applications include improved batteries and battery parts (e.g., electrolytes, separators). Significant advantages are provided. With the development of such electrolytes and separators, batteries can have improved safety and longevity. This work can also provide improved cost-effectiveness by using separators with locally anisotropic pore structures or columnized membranes to modify any existing electrolytes to attain locally anisotropic behaviors. This approach avoids the need to explore new electrolyte chemistries experimentally and for certification, resulting in significant cost savings.

### BRIEF DESCRIPTION OF THE DRAWINGS

FIG. 1 is a schematic representation of a 2-D half-cell domain. The coordinate system moves in the positive x direction with velocity U, which is the average deposition rate on the electrode.

FIG. 2 shows exemplary spatial profiles of base-state cation concentration, anion concentration, electric potential, and charge density.

FIG. 3 shows spatial profiles of the normalized longitudinal diffusion coefficient for two cell lengths and several values of electric potential.

FIG. 4 shows spatial profiles of base-state charge density for constant diffusion coefficients and field-dependent diffusion coefficients (for several values of electric potential).

FIG. 5 shows dispersion relations for constant diffusion coefficients and field-dependent diffusion coefficients (for several values of electric potential), for L=0.5 μm.

FIG. 6 shows dispersion relations for constant diffusion coefficients and field-dependent diffusion coefficients (for several values of electric potential), for L=5 μm.

FIG. 7 shows dispersion relations for constant isotropic diffusion coefficients and constant anisotropic diffusion coefficients for several levels of anisotropy.

FIG. 8 is a comparison of a dispersion relation according to the present model with a dispersion relation assuming a transient base-state solution from the literature.

FIG. 9 is a table showing parameter values for this work.

FIG. 10 schematically shows a metal battery.

FIG. 11 schematically shows 1-D ionic conducting channels in a polymer.

FIG. 12 is a chemical structure diagram of an exemplary surfactant.

FIGS. 13A-C show exemplary separator configurations for use in embodiments of the invention.

FIGS. 14A-B show exemplary electrode coating configurations for use in embodiments of the invention.

FIG. 15 shows an exemplary electrode surface roughness configuration for use in embodiments of the invention.

### DETAILED DESCRIPTION

Section A describes a detailed modeling analysis of dendrite growth in Li-metal batteries. Section B describes several approaches for suppressing dendrites in batteries suggested by the analysis of section A.

### A) Li-Metal Battery Modeling Example

### A1) Introduction

Dendritic growth of lithium metal is a leading cause of degradation and catastrophic failure of Li-metal batteries. Understanding the unstable dendrite growth during electrodeposition, which has been observed in many experimental studies, is crucial to the design and safe operation of Li-metal batteries. Linear stability analyses can reveal important aspects of the dynamics associated with these instabilities. Of direct relevance to our study are investigations of the possible stabilizing effects of a negative background charge in porous media and of dependence of the crystal grain size on duty cycle in pulse electroplating. Linear stability analyses of electrodeposition were also used to study the mechanical stabilization effects of external pressure, elastic deformation and electroconvection, as well as other stabilization mechanisms such as thin-film piezoelectricity and superimposition of AC forcing on a base DC field.

These and other similar stability analyses rest on the assumption of local electroneutrality. Although this simplification is adequate under normal operating conditions, the deviation from electroneutrality can be significant when the applied current is high. Investigations of this regime, in which the cell overpotential ranged between 1.9 V and 3.7 V, aim to understand Li-metal battery cycling performance and dendrite growth on the fast-charging lithium-metal anode. In such an overlimiting regime, the electrode surface becomes highly unstable. The lack of electroneutrality implies the existence of an extended space-charge region that significantly affects ion transport in the entire system. It affects transport properties of the electrolyte, such as possible anisotropy of ion diffusion and dependence of the disparate diffusion coefficients of cations and anions on a strong electric field gradient near the electrode surface.

Anisotropy of ion diffusion in the electrolyte may provide a means to control dendritic growth of the lithium metal, because large gradients in the ion concentration parallel to the electrodes play a destabilizing role. Dendrite formation and growth can be suppressed either by using an anisotropic electrolyte or by inducing the anisotropy via application of an electric field, which engenders ionic drift diffusion and changes the transport properties. Recent molecular dynamics simulations also show that electric fields alter the diffusion coefficients of cations and anions in the electrolyte and render them direction-dependent.

Motivated by these findings, we perform a linear stability analysis of electrodeposition without resorting to the electroneutrality assumption. Our study extends the stability analysis to include the mechanisms by which a local electric field close to the electrode surface alters ion diffusion and enhances its anisotropic behavior. The base- and perturbed-state equations are solved numerically to compute the spatial distributions of the electric potential, charge density, and Li-ion concentration. These numerical solutions allow us to construct dispersion relations for the parameter space of interest. The comparison of the stability conditions with and without the electric field effects identifies potential mechanisms for reducing, and even suppressing, dendritic growth. In the vicinity of the electrode surface, larger values of the applied electric potential magnify the impact of (potential-dependent) ionic diffusivity on both the maximum growth rate and charge density. For example, the maximum growth rate is about 24% smaller than its counterpart for the constant isotropic diffusion coefficient.

### A2) Mathematical Formulation

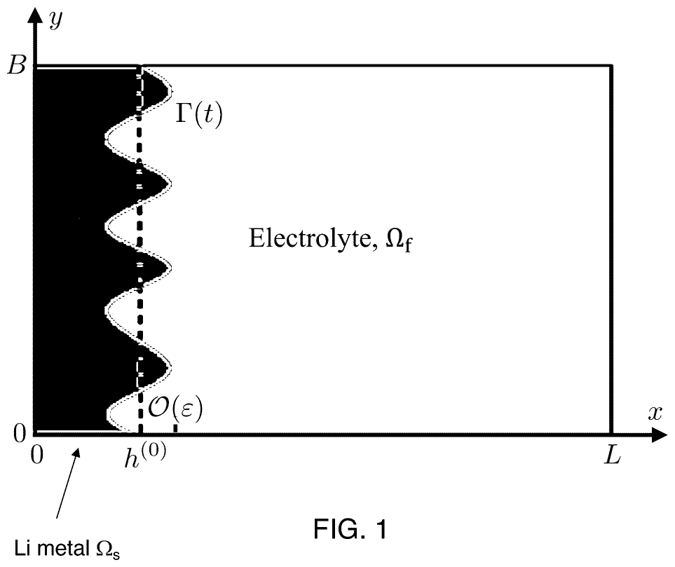

We study electrodeposition on the lithium anode in a two-dimensional half-cell domain, Ω=ωₛ∪Ω_{f} (FIG. 1). The Li-metal electrode surface Γ(t), which separates the Li-metal anode Ωₛ(t) from the liquid electrolyte Ω_{f}(t), is initially located at x=0. A negative electrostatic potential, ϕₑ, is maintained on Γ(t); the electric potential at the outer edge of the electrolyte (x=L) is fixed at 0. The initial concentration of lithium cations, Li⁺, in the binary dilute electrolyte is c₀. At the electrode surface, Γ, the cations, Li⁺, undergo a Faradaic reaction with electrons, e⁻, and reduce to Li atoms, Li⁺+e⁻→Li, which are subsequently deposited on the electrode surface.

This deposition causes the Li-metal surface Γ(t) to change with time t. We study this evolution in the two-dimensional Cartesian coordinate system spanned by the orthogonal unit-vectors eₓ and e_{y}, and represent the moving interface, Γ(t), by a single-valued function h(y, t) such that h(y, 0)=0 (FIG. 1). Our focus is on the stability of the electrodeposition, i.e., of the temporal evolution of h(y, t).

Governing equations: Under isothermal conditions and in the absence of a magnetic field, the state of an immobile dilute electrolyte at any point x=(x,y)^{T}∈Ω_{f}={x:h(y,t)≤x≤L,0≤y≤B} and time t is defined by the concentrations (mol/m³) of cations, c₊(x, t), and anions, c₋(x, t), and by the electric potential ϕ(x, t) (V). Spatial variability of these three state variables induces mass fluxes of cations, J₊(x, t), and anions, J₋(x, t),

$${J}_{\pm } = - {D}_{\pm } ( ∇ {c}_{\pm } + \frac{{z}_{\pm } {c}_{\pm } F}{RT} ∇ ϕ ) \qquad ( 1 a )$$

where D_{±} are the diffusion coefficients (m² s⁻¹), whose tensorial nature accounts for possible anisotropy; z_{±} are the charge numbers (valences) of the cations and anions; F is the Faraday constant (s·A mol⁻¹); R is the gas constant (J/mol/K); and T is the temperature (K). Mass conservation of ions in the electrolyte is described by the Nernst-Planck equations,

$$\frac{\partial {c}_{\pm }}{\partial t} = - ∇ \cdot {J}_{\pm } , x ∈ {Ω}_{f} , t > 0 \qquad ( 1 b )$$

The electric potential, ϕ, is governed by the Poisson equation,

$$- ϵ {∇}^{2} ϕ = {z}_{+} {Fc}_{+} + {z}_{-} {Fc}_{-} , x ∈ {Ω}_{f} , t > 0 \qquad ( 2 )$$

where ϵ is the absolute permittivity of the solvent (F m⁻¹).

The electrode's surface is impervious to inert (non-reactive) anions, i.e.,

$$n \cdot {J}_{-} = 0 , x ∈ Γ , t > 0 \qquad ( 3 )$$

where n is the normal vector pointing outward from the electrolyte. The normal component of the cation flux, J₊, through this surface is balanced by the Faradaic reaction Li⁺+e⁻→Li such that

$$n \cdot {J}_{+} = {R}_{Li} , x ∈ Γ , t > 0 \qquad ( 4 a )$$

where R_{Li} is the rate of production of lithium atoms. This condition is supplemented with the minimum Li+ concentration condition at the electrode surface:

$$n \cdot ∇ {c}_{+} = 0 , x ∈ Γ , t > 0 \qquad ( 4 b )$$

The production rate R_{Li} is given by the Butler-Volmer equation,

$${R}_{Li} = - \frac{{k}_{0}}{{γ}_{ts}} [ exp ( {α}_{an} \frac{zF {η}_{α} + 2 ωγκ}{RT} ) - \frac{{c}_{+} ( x ∈ Γ , t )}{{c}_{+}^{Θ}} exp ( - {α}_{cat} \frac{zF {η}_{α} + 2 ωγκ}{RT} ) ] \qquad ( 5 )$$

where k₀ is the reaction rate constant (mol/m²s⁻¹); γₜₛ is the activity coefficient of the transition state for the Faradaic reaction (−); z is the number of electrons involved in the electrode reaction; αₐₙ and α_{cat} are the anodic and cathodic charge-transfer coefficients, respectively (−); c₊^{Θ} is the standard concentration; ω is the molar volume of Li metal (m³ mol⁻¹); γ is the isotropic surface energy of the Li metal (J m⁻²), and κ(y, t) is the mean curvature of Γ(t) (m⁻¹). The activation overpotential η_{α}(x∈Γ,t) is defined as

$${η}_{α} = {ϕ}_{e} - ϕ ( x ∈ Γ , t ) - {E}^{Θ} \qquad ( 6 )$$

where E^{Θ} is the standard electrode potential. For the sake of specificity, we set γₜₛ=1, αₐₙ=1−α_{cat}, and E^{Θ}=0. The interfacial current density I is related to the reaction rate R_{Li} by

$$I = {zFR}_{Li} \qquad ( 7 )$$

The boundary conditions on the moving interface Γ(t), Eqs. 3 and 4, are supplemented with a kinematic condition that describes the spatiotemporal evolution of Γ. The normal-vector n(y, t) and mean curvature κ(y, t) of Γ are expressed in terms of the derivatives of h(y, t) as

$$n = \frac{1}{\sqrt{1 + {( {\partial }_{y} h )}^{2}}} ( \begin{matrix}- 1 \\ {\partial }_{y} h\end{matrix} ) \\ κ = - \frac{1}{2} \frac{{\partial }_{y}^{2} h}{{[ 1 + {( {\partial }_{y} h )}^{2} ]}^{3 / 2}} \qquad ( 8 )$$

The rate of change of Γ(t), or equivalently of h(y, t), is given by the current into the anode,

$${e}_{x} \cdot n \frac{\partial h ( y , t )}{\partial t} = - \frac{ω I}{zF} \qquad ( 9 )$$

The boundary conditions on the remaining segments of the computational domain Ω_{f} are

$$ϕ = 0 , {c}_{+} = {c}_{0} , {c}_{-} = {c}_{0} , for x = L \qquad ( 10 a )$$

$$\frac{\partial ϕ}{\partial y} = 0 , \frac{\partial {c}_{+}}{\partial y} = 0 , \frac{\partial {c}_{-}}{\partial y} = 0 , for x = 0 and B \qquad ( 10 b )$$

The boundary conditions at x=L reflect an assumption that small (magnitude E) perturbations of the anode surface do not affect the ion concentrations the half-cell distance away; this assumption is effectively enforced in the full-cell linear stability analyses that impose identical perturbations on both cathode and anode. The last three boundary conditions in Eq. 10 imply that the horizontal surfaces, y=0 and B, are electrically insulated and impermeable.

### Diffusivity Alteration by Electric Field:

The presence of an electric field, E=(Eₓ=−∂ₓϕ,E_{y}=−∂_{y}ϕ), alters the diffusion coefficients of cations and anions, rendering them direction-dependent, D_{±}. Both the magnitude of the diffusion coefficients and the degree of their anisotropy increase with the magnitude of Eₓ or E_{y}. We adopt the exponential model derived from the molecular dynamics simulations of 1M solution of LiPF6 in ethylene carbonate,

$${D}_{\pm } = {D}_{\pm }^{ref} ( \begin{matrix}{e}^{{b}_{\pm } \vert {E}_{x} \vert} & 0 \\ 0 & {e}^{{b}_{\pm } \vert {E}_{y} \vert}\end{matrix} ) = {D}_{\pm }^{ref} ( \begin{matrix}{e}^{{b}_{\pm } {\partial }_{x} ϕ} & 0 \\ 0 & {e}^{{b}_{\pm } {\partial }_{y} ϕ}\end{matrix} ) \qquad ( 11 )$$

where D_{±}^{ref} are the isotropic diffusion coefficients of cations and anions when |E|=0, and the fitting parameters b_{±}(m V⁻¹) account for the strength of the electric field.

Like many others, our model of dendritic growth, Eqs. 1-10, rests on the dilute-solution formulation. Measurements of the activity coefficient for LiPF6 in PC/EC/DMC for a wide range of concentration (up to 4M) found it to be close to 1 for concentrations up to 1M, indicating that the dilute formulation holds. This finding is seemingly contradicted by the study that found the solutions of LiPF6 in PC/EC/EMC for the concentration range 0.0625-1M not to be “dilute”; yet, it showed that the dilute-solution model of these solutions overestimates the specific energy of a lithium-ion cell by only 0.6%. Be that as it may, our analysis can accommodate other dependencies of D_{±} on E, and the one in Eq. 11 is used for the sake of concreteness.

### A3) Linear Stability Analysis

Linear stability analysis is performed by applying a small perturbation, ε exp(wt+iky), to a one-dimensional steady-state base state, h⁽⁰⁾)(t)≡Ut, ϕ⁽⁰⁾(x) and c_{±}⁰(x). Here, ε is the small dimensionless parameter, w is the growth rate (1/s), k is the wave number (1/m), and i²=−1. The electrodeposition process is unstable if the perturbations grow with time, i.e., if w>0. The goal of a stability analysis is to express w in terms of the physical properties of the electrolyte and the anode.

To facilitate this analysis, we rewrite Eqs. 1-11 in terms of dimensionless variables

$$\tilde{x} = \frac{x}{L} , \tilde{y} = \frac{y}{L} , \tilde{t} = \frac{{tD}_{+}^{ref}}{{L}^{2}} , {\tilde{c}}_{\pm } = \frac{{c}_{\pm }}{{c}_{0}} \\ \tilde{ϕ} = \frac{F ϕ}{RT} , \tilde{h} = \frac{h}{L} , \tilde{U} = \frac{UL}{{D}_{+}^{ref}} \\ {\tilde{D}}_{\pm } = \frac{{D}_{\pm }}{{D}_{+}^{ref}} , {\tilde{b}}_{\pm } = \frac{{RTb}_{\pm }}{FL} , {\tilde{λ}}_{D}^{2} = \frac{RT ϵ}{2 {L}^{2} {F}^{2} {c}_{0}} \\ Ca = \frac{ωγ}{RTL} , {\tilde{R}}_{Li} = \frac{{LR}_{Li}}{{D}_{+}^{ref} {c}_{0}} \qquad ( 12 a )$$

The corresponding dimensionless parameters describing the perturbation of the anode surface, Γ, are

$$\tilde{k} = kL , \tilde{w} = \frac{{L}^{2} w}{{D}_{+}^{ref}} \qquad ( 12 b )$$

The dimensionless Li production rate R̅_{Li} and interfacial current density Ī are

$${\tilde{R}}_{Li} = - {\tilde{k}}_{0} {e}^{- {α}_{cat} ( z {\tilde{η}}_{α} + 2 \tilde{ω} \tilde{κ} )} [ {e}^{z {\tilde{η}}_{α} + 2 Ca \tilde{κ}} - \frac{{\tilde{c}}_{+}}{{\tilde{c}}_{+}^{Θ}} ] \\ \tilde{I} = \frac{I}{{I}_{lim}} = \frac{z {\tilde{R}}_{Li}}{2} \qquad ( 12 c )$$

$$where$$

$${\tilde{k}}_{0} = \frac{{Lk}_{0}}{{D}_{+}^{ref} {c}_{0} {γ}_{ts}} , {\tilde{η}}_{α} = \frac{F {η}_{α}}{RT} , \tilde{κ} = L κ \\ {\tilde{c}}_{+}^{Θ} = \frac{{c}_{+}^{Θ}}{{c}_{0}} , {I}_{lim} = \frac{2 {FD}_{+}^{ref} {c}_{0}}{L} \qquad ( 12 d )$$

Unless specified otherwise, all the quantities discussed from here on are dimensionless, even though we drop the tildes to simplify the notation. In a linear analysis, the electrode surface height, h(y, t), and the state variables ϕ(x, t) and c_{±}(x, t) are written as

$$h ( y , t ) = {h}^{( 0 )} ( t ) + ε {h}^{( 1 )} {e}^{wt + iky} \qquad ( 13 )$$

$$ϕ ( x , t ) = {ϕ}^{( 0 )} ( x ) + {εϕ}^{( 1 )} ( x ) {e}^{wt + iky} \qquad ( 14 )$$

$${c}_{\pm } ( x , t ) = {c}_{\pm }^{( 0 )} ( x ) + ε {c}_{\pm }^{( 1 )} ( x ) {e}^{wt + iky} \qquad ( 15 )$$

where the constant h⁽¹⁾ and the functions ϕ⁽¹⁾ and c_{±}⁽¹⁾ are the first-order (in ε) corrections. Then, the interfacial conditions 3-11 are expanded in Taylor series around the leading-order interface h⁽⁰⁾, which is moving with the constant velocity U=dh⁽⁰⁾/dt=−ωR_{Li}⁽⁰⁾; e.g., ϕ(x∈Γ, t)≈ϕ(h⁽⁰⁾,y,t)+ . . . . Finally, the terms of equal power of ε are collected to specify boundary-value problems (BVPs) for the base state (of order ε⁰) and the first-order correction (of order ε).

For the following results, these BVPs were numerically solved in Matlab™. The base-state BVP (order ε⁰) was solved numerically with the Matlab™ function bvp4c to obtain the zeroth order solution and the necessary first and second-order derivatives. These are then used as coefficients in the first order BVP (order ε¹); the numerical solution is obtained by employing a second-order finite-difference scheme and solving the resulting generalized eigenvalue problem with the Matlab™ function eigs.

### A4) Results and Discussion

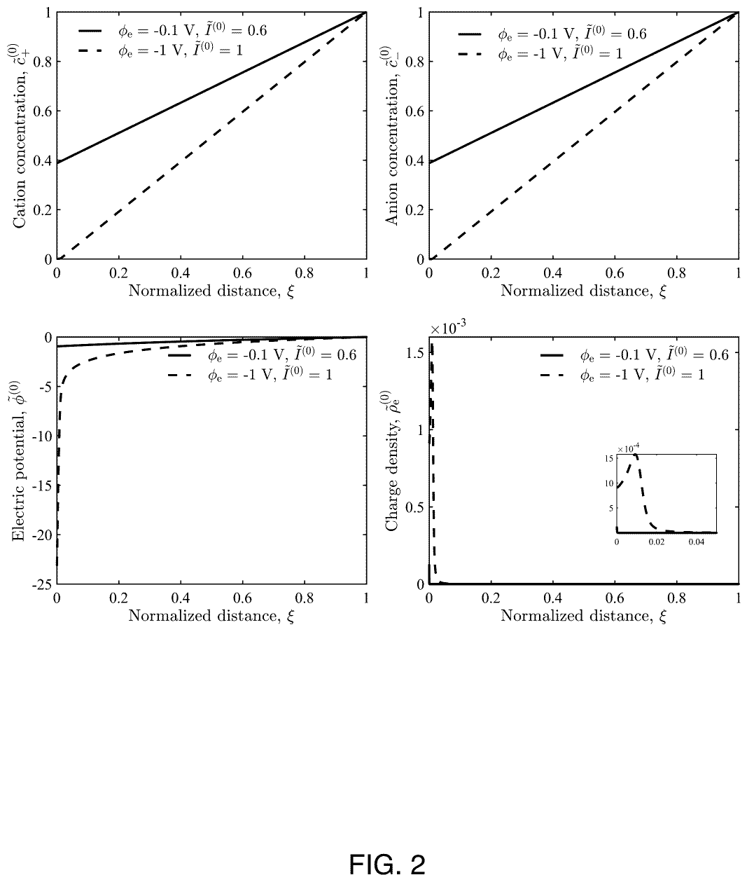

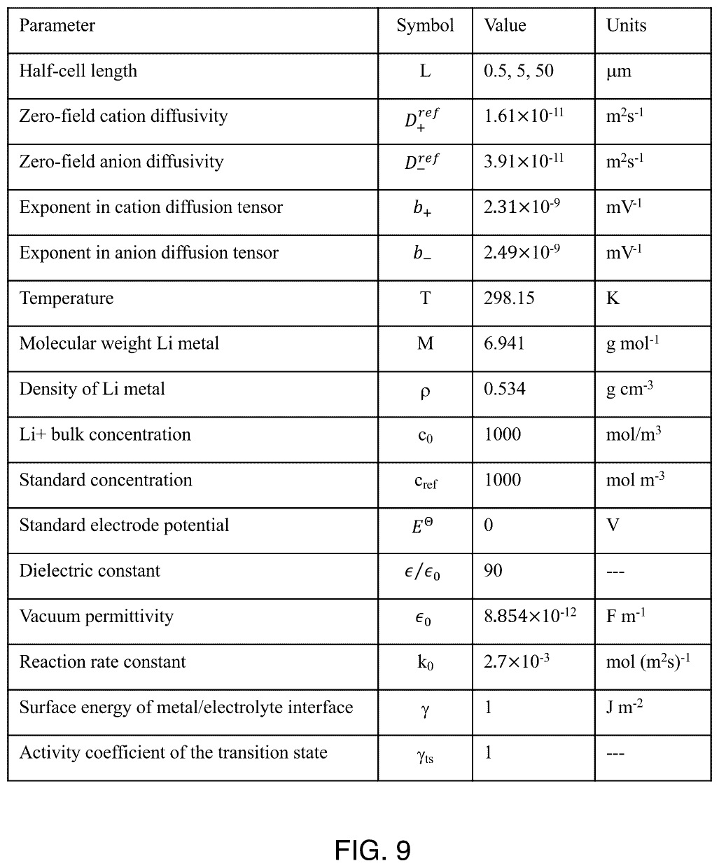

The parameters used in our simulations are presented in the table of FIG. 9. We start by computing the base-state solution for constant isotropic diffusion coefficients, D_{±}, (i.e., for Eq. 11 with b_{±}=0) for a wide range of the applied electric potential ϕₑ. FIG. 2 shows the concentrations of cations, \tilde{c}₊⁽⁰⁾, and anions, \tilde{c}₋⁽⁰⁾; the charge density \tilde{ρ}ₑ⁽⁰⁾=c₊⁽⁰⁾−c₋⁽⁰⁾; and the electric potential \tilde{ϕ}⁽⁰⁾. These dimensionless quantities are computed for the half-cell length L=5 μm, which corresponds to the limiting current density Iₗᵢₘ=2FD₊^{ref}c₀/L=62.1 mA/cm². For small values of the applied potential, ϕₑ=−0.1V, the base-state current density I⁽⁰⁾ is smaller than Iₗᵢₘ, the cations at the electrode surface are not depleted, and electroneutrality holds throughout the simulation domain. On the other hand, for large ϕₑ when I⁽⁰⁾ reaches Iₗᵢₘ, the Li-cation concentration c₊⁽⁰⁾(ξ) is approximately zero near the electrode surface and local electroneutrality is violated within the boundary layer, 0≤ξ≤0.02; for L=5 μm, its width is 0.02·5=0.1 μm. FIG. 2 also shows that higher values of the applied potential ϕₑ induce larger values of the electric potential gradient, ∂_{ξ}ϕ⁽⁰⁾, near the electrode surface.

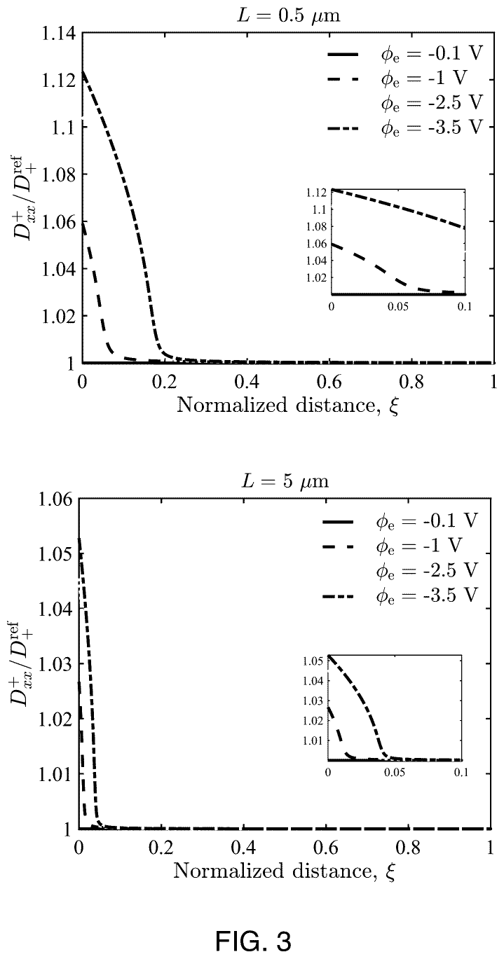

In accordance with Eq. 11, the electric field E=−∇ϕ gives rise to anisotropic ionic diffusion. Since for the base state E⁽⁰⁾=(−jϕ⁽⁰⁾,0)^{T}, the leading-order approximations of the principal components of the diffusion tensor D_{±}⁽⁰⁾ in Eq. 17 become Dₓₓ^{±}=D_{±}^{ref} exp(b_{±}j_{ϕ}⁽⁰⁾) and D_{yy}^{±}=D_{±}^{ref}, i.e., the diffusion anisotropy manifests itself in the boundary layer adjacent to the electrode. FIG. 3 shows the spatial extent of this region for half-cell lengths L=0.5 and 5 μm. Both the anisotropy ratio Dₓₓ⁺/D_{yy}⁺ and the boundary-layer width increase as L decreases, or ϕₑ increases, with the longitudinal diffusion coefficient Dₓₓ⁺ being up to 12% larger than its reference value D₊^{ref} for L=0.5 μm and ϕₑ=−3.5 V.

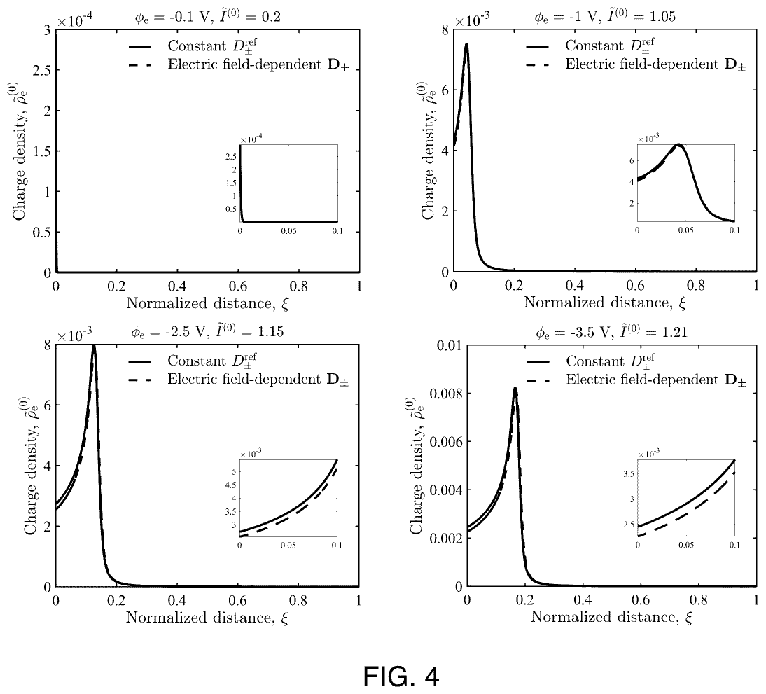

Next, we investigate the impact of the electric field-dependence of ion diffusion on electrodeposition. Specifically, we compare the base-state charge density \tilde{ρ}ₑ⁽⁰⁾ and the perturbed-state growth rates \tilde{w} alternatively computed with either constant diffusion coefficients D_{±}^{ref} or field-dependent diffusion coefficients D_{±}. When the applied electric potential is small (ϕₑ=−0.1 V) the dependence of the diffusion coefficients on the electric field has negligible effect on the charge density \tilde{ρ}ₑ (FIG. 4). This is because in this regime the electric field E is approximately zero (FIG. 2). Higher values of the applied electric potential (ϕₑ=−2.5 and −3.5 V) produce the boundary layer within which the electrolyte is not electroneutral, E>0, the diffusion anisotropy increases, and the base-state charge density ρₑ⁽⁰⁾ near the electrode surface decreases relative to that predicted for the constant diffusion coefficient.

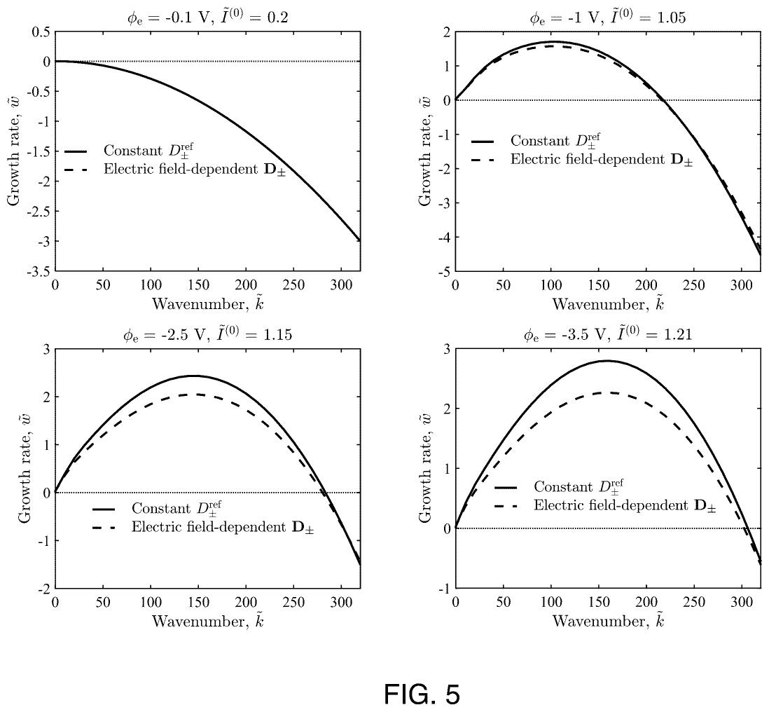

These relatively small and localized changes in electroneutrality (FIG. 2) and charge density (FIG. 4) have significant impacts on the dendrite growth rate \tilde{w} when the applied electric potential ϕₑ becomes large (FIG. 5). For small ϕₑ, i.e., for underlimiting current (I⁽⁰⁾<Iₗᵢₘ), the growth rate \tilde{w} is negative for all wavenumbers \tilde{k}>0. This means that the electrode surface growth is unconditionally stable, i.e., a small initial perturbation of the surface geometry decays with time, regardless of whether or not the diffusion tensor D_{±} depends on the electric field E. For larger ϕₑ (overlimiting current, I⁽⁰⁾>Iₗᵢₘ), the growth rate w is positive within a certain range of \tilde{k}, where the surface growth is unstable and dendrites develop. The dispersion relation \tilde{w}=\tilde{w}(\tilde{k}) exhibits non-monotonic behavior: \tilde{w} increases from zero at \tilde{k}=0 to its maximum value of \tilde{w}ₘₐₓ at \tilde{k}ₘₐₓ wherein the electrode surface growth is maximally unstable; further increase of \tilde{k} causes the positive growth rate \tilde{w} to decrease until it reaches 0 at a critical wavenumber \tilde{k}_{cr} at which point the electrode surface is marginally stable. For \tilde{k}>\tilde{k}_{cr}, the growth rate \tilde{w} becomes negative, and surface energy stabilizes the electrode surface growth. The surface energy has a stabilizing effect on the surface growth at large \tilde{k} by imposing an energy penalty on the creation of additional surface area. The difference between the dispersion relations \tilde{w}=\tilde{w}(\tilde{k}) corresponding to constant diffusion coefficients D_{±}^{ref} and their electric field-dependent anisotropic counterparts D_{±} increases with ϕₑ. For ϕₑ=−3.5 V, the use of D_{±}^{ref} instead of D_{±} would overestimate ωₘₐₓ by 24%, while \tilde{k}_{cr} remains virtually unchanged.

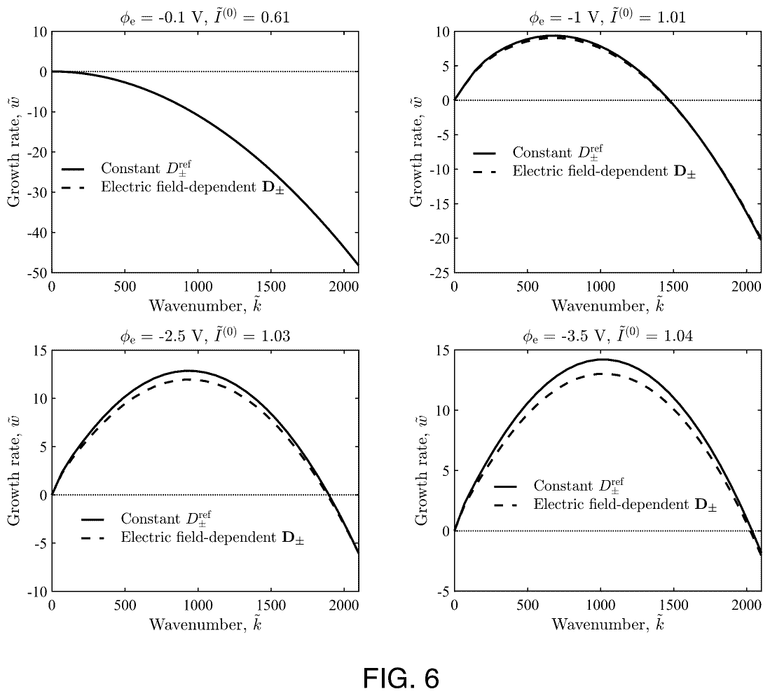

In another set of numerical experiments, we study how the half-cell length L affects the stability of the electrode interface growth. FIG. 6 shows the dispersion relations \tilde{w}=\tilde{w}(k) corresponding to constant isotropic diffusion coefficients D_{±}^{ref} and the electric field-dependent diffusion tensors D_{±}, for L=5 μm (although not shown here, we have observed the same trend for L=50 μm). The maximum growth rate \tilde{w}ₘₐₓ increases with L. The impact of the electric field-dependency of the diffusion coefficient on the dispersion relation \tilde{w}=\tilde{w}(\tilde{k}) decreases with L. That is because the change in \tilde{D}ₓₓ^{±} is confined to the boundary layer adjacent to the electrode, and the width of this layer as a small fraction of the total cell decreases with L (FIG. 3).

The local electric field impacts ion diffusion in two ways: it alters the magnitude of the ionic diffusion coefficients and enhances their anisotropic nature. To isolate the contribution of each factor, we conduct two sets of numerical experiments. In the first, we simulate electrolytes with isotropic diffusion coefficients D_{±}=D_{±}^{ref}; with D_{±}=1000D_{±}^{ref}; and with the anion diffusivity D₋=D₋^{ref} and cation diffusivity D₊=1000D₊^{ref}. Although not shown here, we found that modifying D₋ has no effect and modifying D₊ has a negligible effect on the dispersion relations in FIGS. 5 and 6.

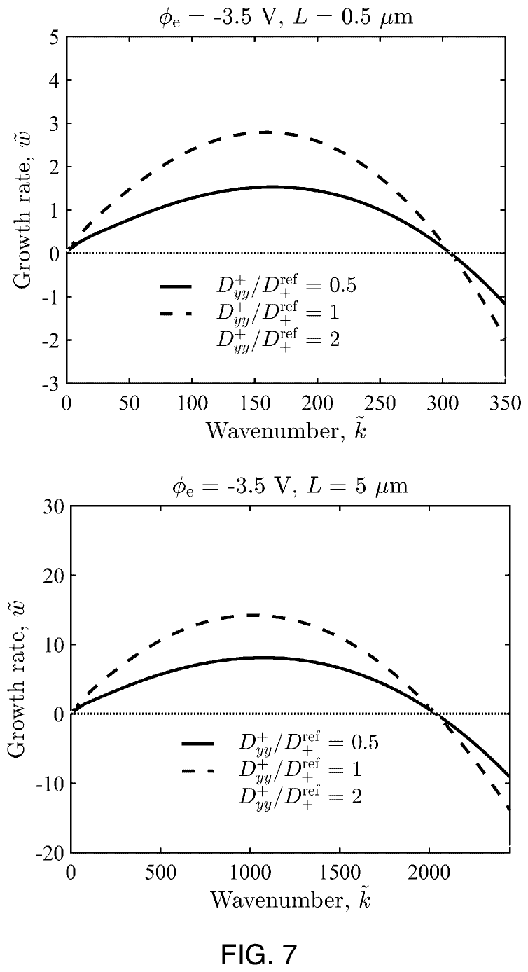

The second set of experiments deals with the stability analysis for electrolytes with constant anisotropic diffusion coefficients,

$${D}_{\pm } = ( \begin{matrix}{D}_{xx}^{\pm } & 0 \\ 0 & {D}_{yy}^{\pm }\end{matrix} ) \qquad ( 16 )$$

where Dₓₓ^{±} and D_{yy}^{±} are the constant diffusion coefficient components in the principal x and y directions. We found the anisotropic behavior of the anion diffusion coefficient D₋ to have no impact on the interfacial dynamics, so we only present results for different anisotropy ratios of the cation diffusion coefficient D₊. The use of D_{±} from Eq. 16 rather than from Eq. 11 does not change the base-state dynamics. FIG. 7 exhibits the dispersion relations \tilde{w}=\tilde{w}(\tilde{k}) corresponding to the constant isotropic diffusion coefficients D_{±}^{ref} and to the constant anisotropic diffusion coefficients Dₓₓ⁺=D₊^{ref}, D_{yy}⁻=Dₓₓ⁻=D₋^{ref} and two values of D_{yy}⁺. The maximum growth rate \tilde{w}ₘₐₓ increases by about 70% or 60% when D_{yy}⁺ doubles from D₊^{ref} to 2D₊^{ref}, for ϕₑ=−3.5 V and L=0.5 μm or L=5 μm, respectively. Enhancing cation diffusion in the direction parallel to the electrode surface (y) decreases the maximum wavenumber \tilde{k}ₘₐₓ, while the critical wavenumber \tilde{k}_{cr} remains unchanged. This finding is in agreement with the numerical simulations of dendrite growth. It is worthwhile contrasting this behavior with that of interfacial growth in multiphase flows, in which increasing the transverse component of the diffusion coefficient tensor stabilizes the interface.

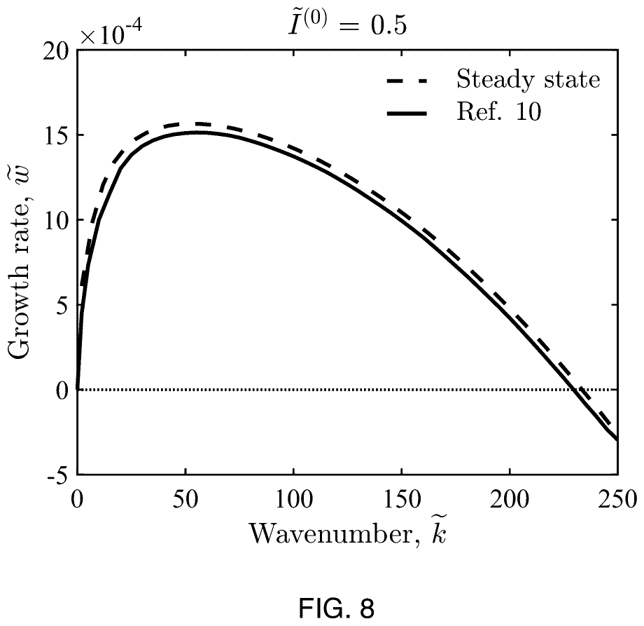

Our stability analysis follows the large body of literature in assuming the base state to be stationary. The transient base-state analysis reveals this assumption to have no effect on the dispersion relation w=w(k) when the current density I is much smaller than the limiting current Iₗᵢₘ (FIG. 8). The importance of the transient base state becomes more pronounced in the over-limiting regime, I>Iₗᵢₘ. However, in this regime the electroneutrality assumption no longer holds. In a follow-up study, we will extend our analysis to account for the transient base state.

### A5) Conclusions

To identify possible mechanisms for control of dendrite growth in Li-metal batteries, we conducted a linear stability analysis of electrodeposition onto the electrode surface. The analysis employs the Poisson-Nernst-Planck equations coupled with the Butler-Volmer kinetics to describe electrodeposition. we do not invoke the assumption of electroneutrality, which is known to break down in the boundary layer adjacent to the electrode surface. Accounting for gradients in the charge distributions allowed us to investigate the stabilizing effects of electric field-dependent anisotropic diffusion of ions on dendritic growth of Li. Our analysis leads to the following major conclusions.
Electric field-dependent anisotropic diffusion reduces both charge density close to the electrode surface and the maximum growth rate of dendrites relative to the values of their counterparts for constant isotropic diffusion.
This effect is most pronounced for large values of the applied electric potential ϕₑ and small half-cell lengths L, e.g., the maximum growth rate is reduced by about 24% when ϕₑ=−3.5 V and L=0.5 μm. Hence, the impact of electric field on ionic diffusion cannot be ignored for batteries with ultra-thin separators.
The local electric field affects ion diffusion and the stability of electrodeposition by altering the diffusion coefficient values and by enhancing the degree of anisotropy. An interplay of these two mechanisms can be used to suppress dendritic growth in Li-ion and Li-metal batteries.

Our findings suggest new strategies for the electrolyte design, i.e., for the optimal selection of solvent and salt and for the tuning of the ionic concentration of solution. Such a design would be informed by the degree to which the electric field affects the electrolyte's transport properties and anisotropic behavior and, ultimately, the dendritic growth. An optimal electrolyte (with additives) would exhibit a strong response to the local electric field in a way that increases the cation diffusion coefficient in the direction perpendicular to the electrode surface.

Another design strategy for the suppression of dendrite growth, suggested by our analysis, is to use anisotropic electrolytes, e.g., liquid crystals, liquid-crystalline physical gels etc., or separators with anisotropic pore structures or columnized membranes. As a dendrite suppression strategy, electrolytes with electric field-dependent diffusion coefficients are appropriate for small batteries, while anisotropic electrolytes reduce dendritic growth in batteries of any size.

Although our linear stability analysis reveals the role of key parameters in dendrite initiation, it does not describe subsequent dendritic growth. The latter requires a numerical solution of surface-evolution equations. In follow-up studies, we will model the dynamics of dendritic growth by solving the nonlinear phase-field equations and compare this solution with the predictions of our linear stability analysis. We also plan to compare the advantages and disadvantages of commonly used commercial liquid electrolytes and to investigate the effects of coating on the dendritic growth of the solid electrolyte surface. The former study would require electrolyte-specific experimental data on the dependence of ionic diffusion coefficients on applied electric field, while the latter analysis will be facilitated by an effective-medium representation of the composite solid electrolyte.

Finally, it is worthwhile emphasizing that our analysis ignores several interfacial phenomena on the anode, which are of potential relevance to Li-dendrite initiation and growth. These include Li-solvation/desolvation and their impact on the formation of solid electrolyte interface. Accounting for these processes is another fruitful venue for future research.

### B) Dendrite Mitigation Strategies

In embodiments of the invention, dendrite formation in metal batteries with liquid electrolytes can be suppressed through the following strategies or any combination thereof. Examples B1, B2, and B3 consider the use or optimization of specific electrolytes to mitigate dendrite growth, while examples B4, B5, and B6 consider viable approaches to alleviate dendrite formation independent of the type of liquid electrolytes used.

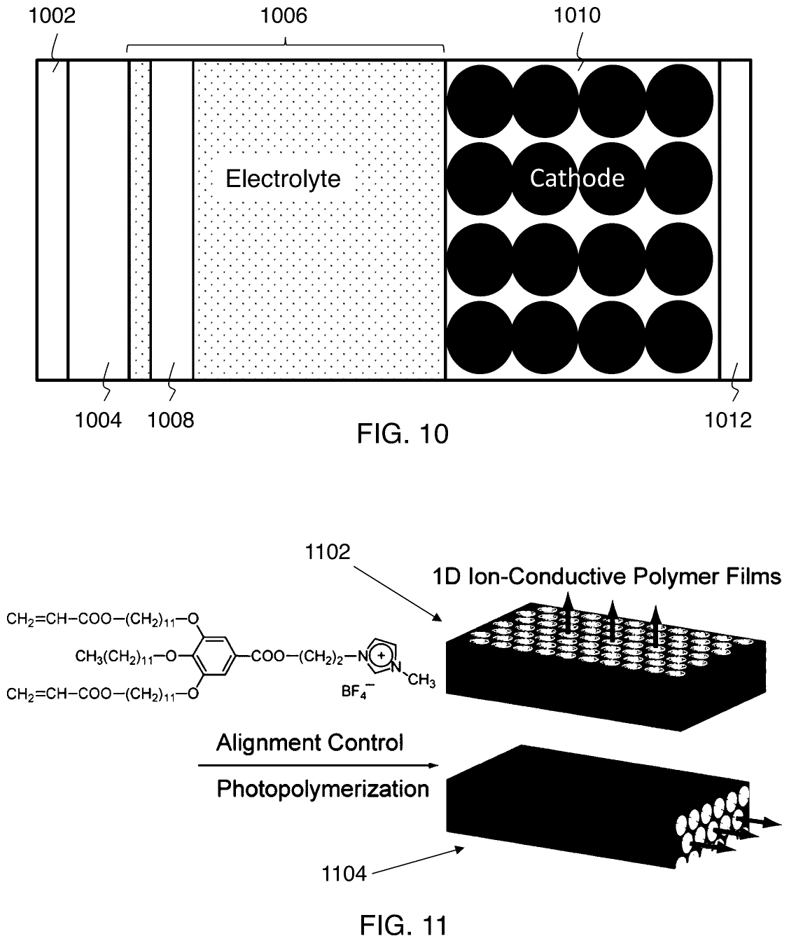

FIG. 10 shows a simplified schematic of a typical metal battery. Here 1002 and 1012 are current collectors, 1004 is the anode, 1006 is the electrolyte, 1008 is the separator, and 1010 is the cathode. In practical battery designs, the separator and electrolyte are not necessarily distinct as shown on FIG. 10. For example, the electrolyte can be disposed in pores or channels of the separator. Any electrolyte/separator configuration can be used, as long as there is ionic conduction between anode and cathode as required by the battery chemistry along with no direct electrical contact between anode and cathode, so that the battery is not shorted out.

### B1) Diffusivity Alteration by Electric Field

In this example, we consider the optimization of existing commercial electrolytes through the selection of solvent and salt and the tuning of the ionic concentration of the solution. Such a design would be informed by the degree to which the electric field affects the electrolytes; transport properties and anisotropic behavior and, ultimately, the dendritic growth on the electrode surface.

Specifically, the presence of an electric field, E=(Eₓ=−∂ₓϕ(E_{y}=−∂_{y}ϕ)^{T}, alters the diffusion coefficients of cations and anions, D_{±}, rendering them direction-dependent, D_{±}. Both the magnitude of the diffusion coefficients and the degree of their anisotropy increase with the magnitude of Eₓ or E_{y}:

$${D}_{\pm } = {D}_{\pm }^{ref} ( \begin{matrix}{e}^{{b}_{\pm } \vert {E}_{x} \vert} & 0 \\ 0 & {e}^{{b}_{\pm } \vert {E}_{y} \vert}\end{matrix} ) = {D}_{\pm }^{ref} ( \begin{matrix}{e}^{{b}_{\pm } {\partial }_{x} ϕ} & 0 \\ 0 & {e}^{{b}_{\pm } {\partial }_{y} ϕ}\end{matrix} )$$

where D_{±}^{ref} are the isotropic diffusion coefficients of cations and anions when |E|=0, and the fitting parameters b_{±} (m/V) account for the strength of the electric field. The above exponential model of ion diffusion coefficients can be obtained from molecular dynamic simulations.

This work suggests that use of a liquid electrolyte that exhibits a strong response to the local electric field (i.e., higher values of b₊), which would increase the cation diffusion coefficient in the direction perpendicular to the electrode surface, can help suppress dendrite growth.

### B2) Ionic Liquid Electrolytes, Liquid Crystal Electrolytes with Localized Concentration or Liquid Crystal Electrolyte Additives

In this example, we consider the use of ionic liquid as potential commercial electrolytes to suppress dendrite growth in metal batteries. The alignment and the self-organization of molecules in the ionic liquid can assist in the formation of domains with anisotropic diffusion coefficients.

We also consider the application of liquid crystals and liquid-crystalline physical gels in the vicinity of the metal surface to suppress dendrite growth in metal batteries. A high concentration of liquid crystal is expected near the electrode surface. These components can also be used as electrolyte additives to obtain anisotropic transport properties to suppress dendrite growth.

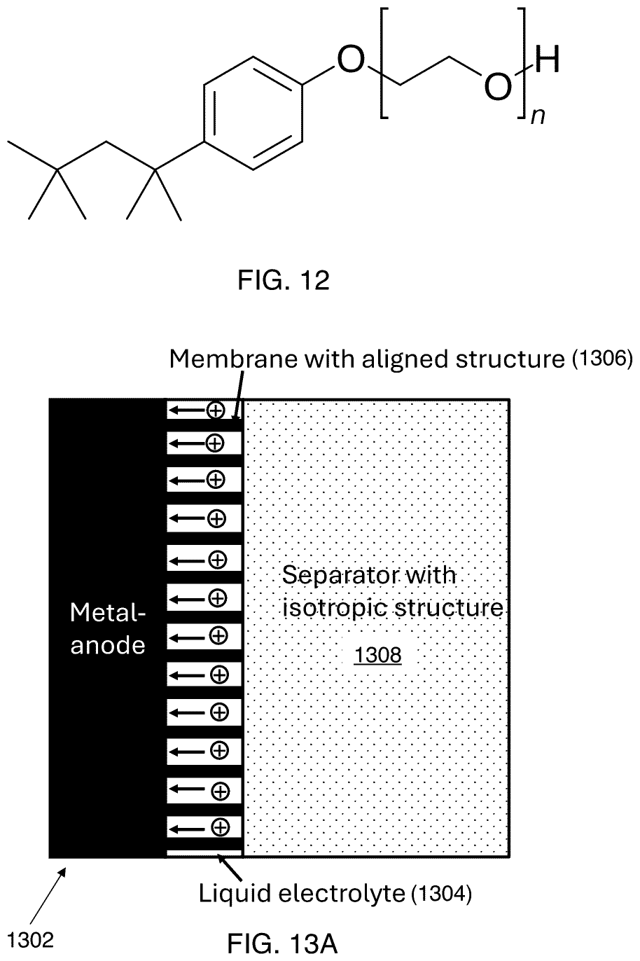

FIG. 11 exhibits the schematic illustration of one-dimensional ion-conductive polymer films that are obtained through the alignment and fixation of ionic channels formed by self-organization of polymerizable columnar liquid crystals of a fan-shaped imidazolium salt having acrylate groups at the periphery. The resulting polymer films can include 1D ionic channels, as in the examples of 1102 and 1104. Our work suggests the presence of such polymer films close to the metal surface can help mitigate dendrite growth. The alignment of the ion conduction channels should be perpendicular to the metal electrode.

### B3) Adding Surfactants to Modify Ion Diffusion

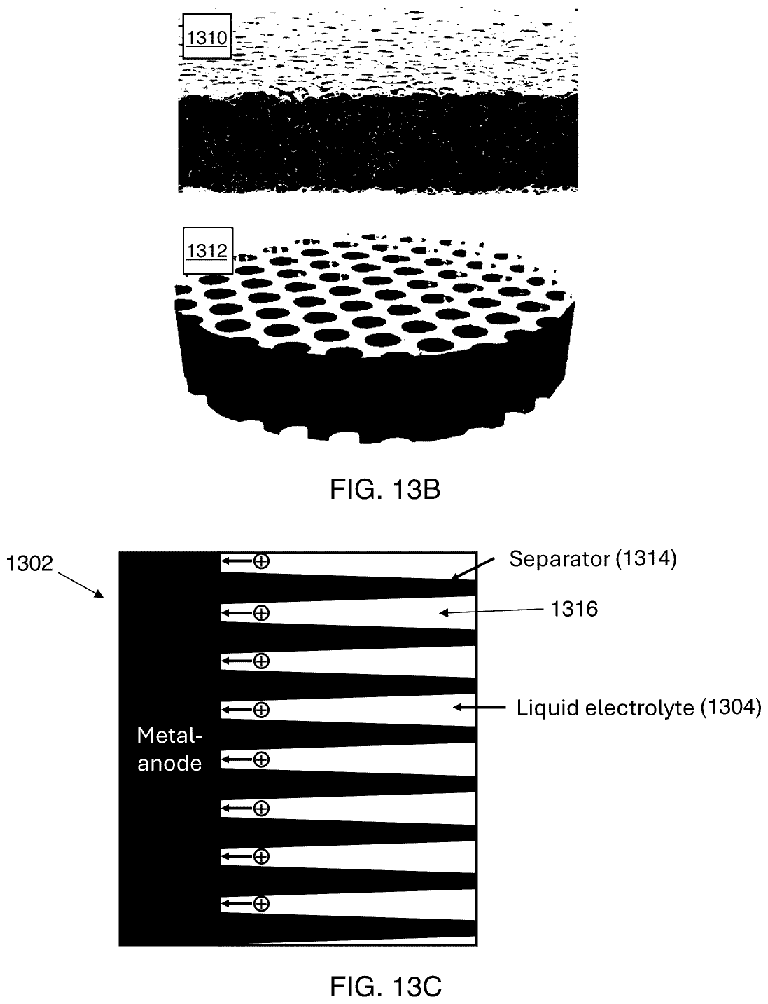

The anisotropic behavior of ion transport in liquid electrolytes, e.g., aqueous electrolytes, can also be achieved by adding surfactants, such as Triton X-100™ (C₁₄H₂₂O(C₂H₄O)ₙ), which is a nonionic surfactant that has a hydrophilic polyethylene oxide chain (on average it has 9.5 ethylene oxide units) and an aromatic hydrocarbon lipophilic or hydrophobic group (FIG. 12).

The introduction of surfactant leads to interfacial aggregations, inducing localized liquid-crystal structures that exhibit anisotropic transport properties for lithium ions. This work recognizes the potential of such surfactants in suppressing dendrite growth.

### B4) Separators with Graded Pore Structures

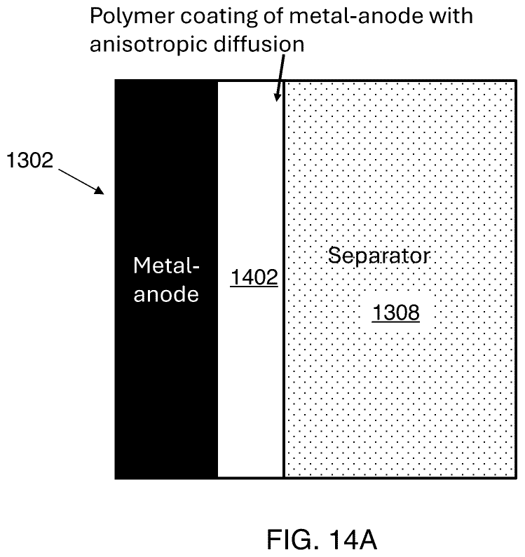

This work also suggests that separators with graded pore structures that enhance the cation diffusion in the direction perpendicular to the electrode near the metal surface can help suppress dendrite growth (FIG. 13A). Here 1302 is the metal anode, 1304 is the liquid electrolyte, 1306 is a membrane on (or part of) the separator with an aligned pore structure, and 1308 is the rest of the separator.

FIG. 13B depicts a schematic representation of two different types of separator membranes related to this design strategy: an isotropic microporous membrane 1310 (shown for comparison) and an anisotropic nanoporous membrane 1312. In the case of the anisotropic nanoporous membrane, the pores are oriented perpendicular to the electrode surface, providing effective pathways for ion transport in a direction that is perpendicular to the lithium metal anode.

FIG. 13C illustrates another schematic of a separator design strategy featuring varying pore sizes 1316 with corresponding separator walls 1314 that enhance cation diffusion perpendicular to the metal electrode surface, thereby aiding in the suppression of dendrite growth.

### B5) Thin Film Coating of Metal Surface

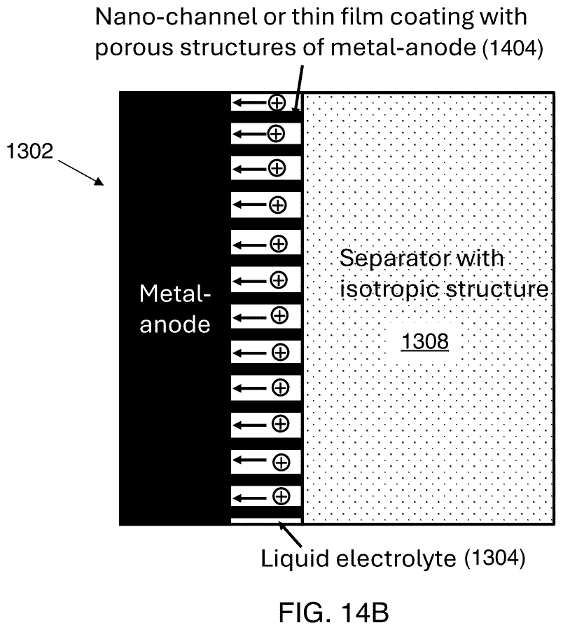

Another alternative strategy to enhance cation diffusion perpendicular to the metal electrode surface to suppress dendrite growth is thin film coating of the metal surface. These strategies include polymer coating, nano-channel, and nano-tube fabrication close to the metal surface, and thin films with porous structures coating the metal surface. FIG. 14A schematically shows thin film 1402 disposed on anode 1302. FIG. 14B is a more detailed view of an example where the thin film coating 1404 has appropriately aligned pores.

### B6) Nano- or Micro-Structured Morphology of the Metal Surface

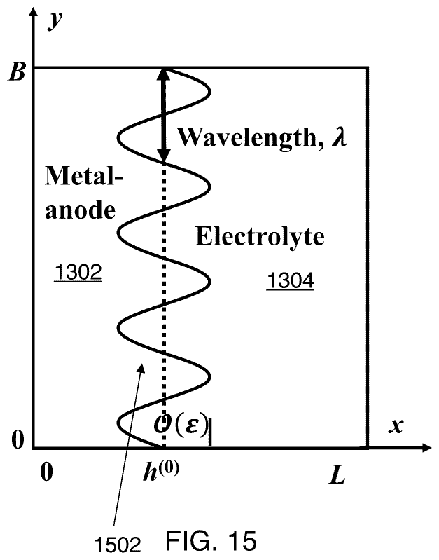

This work suggests that deploying metal anodes whose surface roughness wavelength A is smaller than the critical wavelength λ_{cr}=2π/k_{cr} would ameliorate dendritic growth. The critical wavenumber, k_{cr}, is the wavenumber k for which the growth rate w=0 (as considered in section A). The surface roughness wavelength is inversely proportional to the mean surface curvature K (Eq. 8), i.e., λ∝1/κ. FIG. 15 is a schematic illustration of such metal-anode morphology design, with appropriate surface roughness 1502. Such surfaces can be manufactured with, e.g., nano- or micro-structuring. Quantitative details of the surface roughness design under different operation conditions and with different material properties are informed by the modeling framework (Section A). For example, FIGS. 5-7 present the impact of wavenumber/surface roughness on dendrite initiation under varying operating conditions. Unlike the previous examples where anisotropic diffusion is localized near the electrode surface, this strategy can be applied when the mass diffusion in the electrolyte or separator is isotropic. Dendrite growth is suppressed by increasing surface roughness because the creation of additional surface area results in a surface energy penalty.

1. A battery having suppressed dendrite formation, the battery comprising:
an anode;
a cathode;
an electrolyte disposed between the anode and cathode;
a separator configured to prevent electronic conduction between the anode and the cathode;
wherein dendrite formation in the battery is suppressed by a mechanism selected from the group consisting of: ensuring anisotropic ion transport during battery operation with an anisotropy localized to an electrode-electrolyte interface, and imposing a surface-energy penalty on dendrite formation.

2. The battery of claim 1, wherein the battery is a metal-ion battery selected from the group consisting of: Li batteries, Zn batteries and Na batteries.

3. The battery of claim 2, wherein the battery is a Lithium-ion battery.

4. The battery of claim 1, wherein a cation diffusion coefficient in a direction of a current path of the battery is larger than a cation diffusion coefficient in a direction perpendicular to the current path of the battery.

5. The battery of claim 1, wherein the anisotropy localized to the electrode-electrolyte interface is provided by an electric field.

6. The battery of claim 1, wherein the anisotropy localized to the electrode-electrolyte interface is provided by a surfactant.

7. The battery of claim 6, wherein the surfactant leads to formation of a localized liquid crystal structure.

8. The battery of claim 1, wherein the anisotropy localized to the electrode-electrolyte interface is provided by self-organization of an ionic liquid, liquid crystal, or liquid crystalline gel.

9. The battery of claim 1, wherein the anisotropy localized to the electrode-electrolyte interface is provided by a graded pore structure in the separator.

10. The battery of claim 1, wherein the anisotropy localized to the electrode-electrolyte interface is provided by a thin-film coating deposited on an electrode surface.

11. The battery of claim 1, wherein the surface-energy penalty on dendrite formation is provided by micro-structuring or nano-structuring an electrode surface.
